(19) United States
(12) Patent Application Publication
(10) Pub. No.: US 2025/0238683 A1
(43) Pub. Date: Jul. 24, 2025

(54) Layerwise Multi-Objective Neural Architecture Search for Optimization of Machine-Learned Models

(71) Applicant: Google LLC, Mountain View, CA (US)

(72) Inventors: Yicheng Fan, Mountain View, CA (US); Keshav Kumar, Bengaluru, Karnataka (IN); Andrew Tomkins, Menlo Park, CA (US); Dana Alon, Mountain View, CA (US); Erik Nathan Vee, San Mateo, CA (US); Shanmugasundaram Ravikumar, Piedmont, CA (US); Jingyue Shen, Santa Clara (CN); Daiyi Peng, Cupertino, CA (US)

(21) Appl. No.: 18/596,110

(22) Filed: Mar. 5, 2024

(30) Foreign Application Priority Data
Jan. 23, 2024 (IN) IN202411004510

(51) Int. Cl. G06N 3/0985; G06N 3/04

(52) U.S. Cl. CPC G06N 3/0985; G06N 3/04

(57) ABSTRACT

A search option can be selected for each model layer N of a plurality of model layers M. based on the model layer N, the one or more search options can be used to construct one or more candidate model layers for a model layer N+1 of the plurality of model layers. The one or more candidate model layers are respectively associated with one or more cost metrics. A cost metric is indicative of a cost associated with inclusion of the candidate model layer in an optimized machine-learned model. An optimized machine-learned model comprising M model layers can be constructed based on a cost function. The cost function maximizes an accuracy of the optimized machine-learned model subject to a sum of the cost metrics associated with each candidate model layer included in the optimized machine-learned model being less than a maximum cost.

### PRIORITY CLAIM

The present application is based on and claims priority to Indian Provisional Application 20/241,1004510 having a filing date of Jan. 23, 2024, which is incorporated by reference herein.

### FIELD

The present disclosure relates generally to optimization of machine-learned models. More particularly, the present disclosure relates to layerwise, multi-objective neural architecture search.

### BACKGROUND

With the rapid development and implementation of neural networks and other machine-learned models, the efficiency of models has become an increasingly important factor with regards to their applicability. For example, models are often required to be implemented using limited hardware resources, such as those of a wearable computing device (e.g., a smartwatch, etc.). However, finding optimized architectures for machine-learned models is a time-consuming and error prone task which requires high-skill architecture design experience.

### SUMMARY

Aspects and advantages of embodiments of the present disclosure will be set forth in part in the following description, or can be learned from the description, or can be learned through practice of the embodiments.

One example aspect of the present disclosure is directed to a computing system for layer-wise neural architecture search with polynomial complexity to combinatorically construct an optimized machine-learned model, including one or more processors and one or more non-transitory computer-readable media that store instructions that, when executed by the one or more processors, cause the participant computing device to perform operations. The operations include iteratively constructing, for each model layer of a plurality of model layers, one or more candidate model layers. The operations include determining a cost metric for each of the candidate model layers, wherein a cost metric is indicative of a cost associated with inclusion of the candidate model layer in an optimized machine-learned model. The operations include for each model layer, grouping the one or more respective candidate model layers into one or more candidate layer clusters, wherein each candidate layer cluster is associated with a range of cost metrics. The operations include filtering at least one candidate model layer based the cost metric associated with the candidate model layer being greater than a threshold cost. The operations include constructing an optimized machine-learned model comprising a candidate model layer for each of the plurality of layers based on a cost function, wherein the cost function maximizes a performance metric of the optimized machine-learned model subject to a sum of the cost metrics associated with each candidate model layer included in the optimized machine-learned model being less than a maximum cost.

Another example aspect of the present disclosure is directed to a computer-implemented method to implement layerwise optimization of machine-learned models. The method includes, for each model layer N of a plurality of model layers M, selecting, by a computing system comprising one or more computing devices, one or more layer search options from a plurality of layer search options. The method includes, based on the model layer N, using, by the computing system, the one or more search options to construct one or more candidate model layers for a model layer N+1 of the plurality of model layers, wherein the one or more candidate model layers are respectively associated with one or more cost metrics, wherein a cost metric is indicative of a cost associated with inclusion of the candidate model layer in an optimized machine-learned model. The method includes constructing, by the computing system, an optimized machine-learned model comprising M model layers based on a cost function, wherein the cost function maximizes a performance metric of the optimized machine-learned model subject to a sum of the cost metrics associated with each candidate model layer included in the optimized machine-learned model being less than a maximum cost.

Another example aspect of the present disclosure is directed to one or more non-transitory computer-readable media that store instructions that, when executed by the one or more processors, cause the participant computing device to perform operations. The operations include, for each model layer N of a plurality of model layers M, selecting one or more layer search options from a plurality of layer search options. The operations include, based on the model layer N, using the one or more search options to construct one or more candidate model layers for a model layer N+1 of the plurality of model layers, wherein the one or more candidate model layers are respectively associated with one or more cost metrics, wherein a cost metric is indicative of a cost associated with inclusion of the candidate model layer in an optimized machine-learned model. The operations include constructing an optimized machine-learned model comprising M model layers based on a cost function, wherein the cost function maximizes a performance metric of the optimized machine-learned model subject to a sum of the cost metrics associated with each candidate model layer included in the optimized machine-learned model being less than a maximum cost.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system 100 that performs layerwise multi-objective neural architecture search according to example embodiments of the present disclosure.

FIG. 1B depicts a block diagram of an example computing device 10 that performs layerwise multi-objective neural architecture search according to example embodiments of the present disclosure.

FIG. 1C depicts a block diagram of an example computing device 50 that performs training and evaluation of candidate model layers for layerwise multi-objective neural architecture search according to example embodiments of the present disclosure.

FIG. 2 is a data flow diagram for iteratively selecting candidate layers in a machine-learned model according to example embodiments of the present disclosure.

FIG. 3 depicts a flow chart diagram of an example method to perform layerwise multi-objective neural architecture search according to example embodiments of the present disclosure.

Reference numerals that are repeated across plural figures are intended to identify the same features in various implementations.

### DETAILED DESCRIPTION

### Overview

Generally, the present disclosure is directed to multi-objective neural architecture search for optimization of machine-learned models. More specifically, optimizing machine-learned models can provide substantial benefits, especially when models are expected to be implemented using limited compute resources. However, conventional model optimization techniques can require a substantial expenditure of compute resources. For example, the complexity of many conventional model optimization techniques (e.g., conventional neural architecture searches) scale exponentially, making the optimization of sufficiently large models prohibitively difficult.

Accordingly, implementations of the present disclosure propose a layerwise multi-objective neural architecture search. For example, a computing system can obtain a request for an optimized machine-learned model and a maximum cost for the model. The computing system can determine a cost function that separately evaluates a cost of the model (e.g., based on various model constraints such as latency, size, etc.) and a performance of the model (e.g., accuracy of the model, etc.). Based on the cost function, the computing system can determine, for a model with M layers, the optimal combination of options for all layers needed to achieve a maximum quality of the model subject to the maximum cost.

For a more specific example, the computing system can first construct a search space in a layerwise manner. The computing system can search for a model with M layers, and for each layer, the computing system can select from a set of search options. Based on the assumption that each prior search contains all necessary information to construct optimal models, the computing system can use the selected search option to construct a number of candidate model layers based on a candidate layer from the preceding layer. The computing system can then group the candidate model layers based on their associated cost metrics (e.g., metrics indicating a cost associated with inclusion of the candidate layer). The computing system can iterate through the model to construct an optimal machine-learned model that maximizes a performance of the model subject to the maximum cost.

Aspects of the present disclosure provide a number of technical effects and benefits. As one example technical effect and benefit, due to the exponentially scaling complexity of conventional neural architecture searches, such searches usually require enormous quantities of compute resources to optimize models of a certain size. However, implementations of the present disclosure enable layer-wise, multi-objective neural architecture search with a polynomial complexity, therefore substantially reducing the quantity of compute resources required for model optimization (e.g., compute cycles, energy, memory, storage, etc.) and enabling neural architecture search optimization for models that could not previously be optimized due to their size.

It should be noted that, as described herein, a “search option” can generally refer to a type of layer, a configuration for a layer, parameter adjustments for a layer, or any other type of search option to be performed. For example, the search options could include particular types of models or model layers 9e.g., convolutional layer(s), matmul layer(s), transformer layer(s), etc.). For another example, the search options could be various configurations to apply to a convolutional layer. Specifically, when searching for a model on a particular layer, a computing system can change a search option only for that layer, while keeping previous layers unchanged.

With reference now to the Figures, example embodiments of the present disclosure will be discussed in further detail.

### Example Devices and Systems

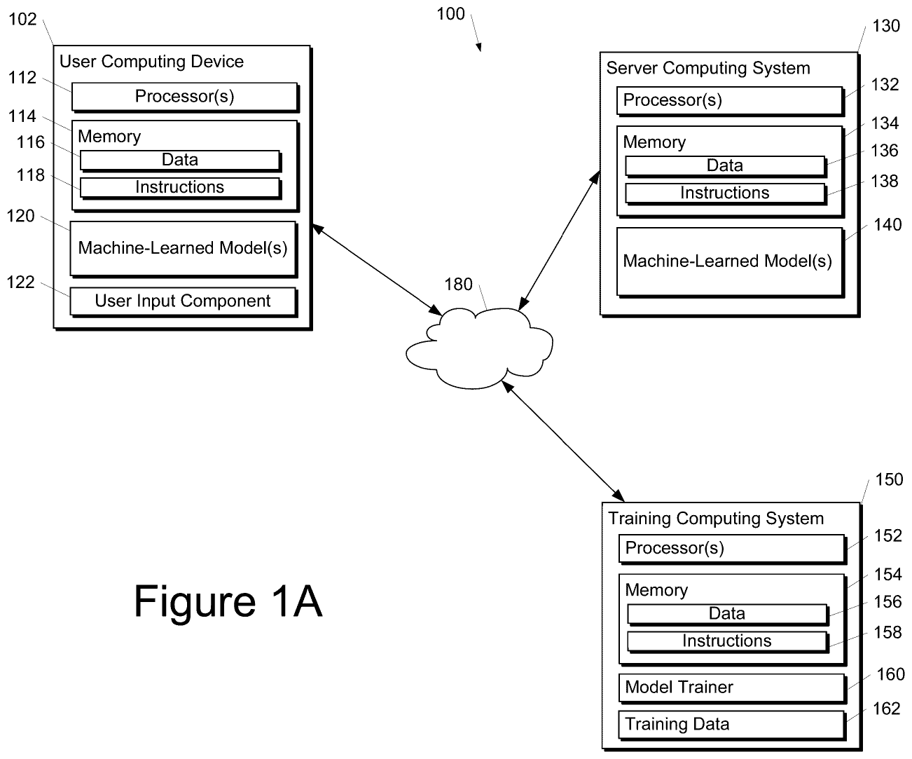

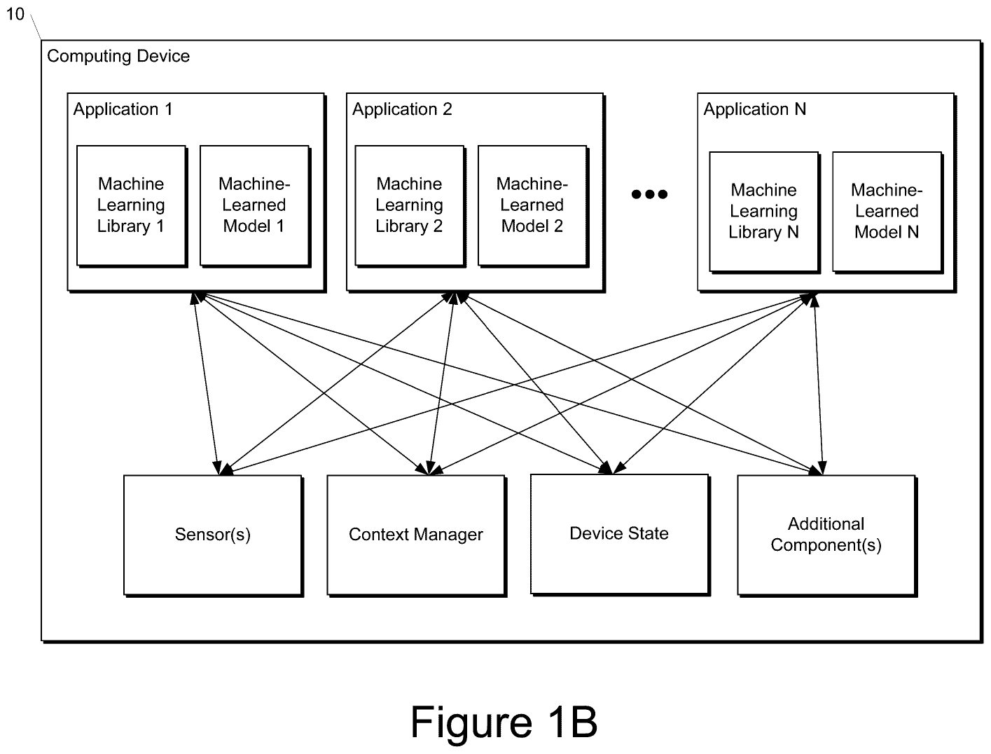

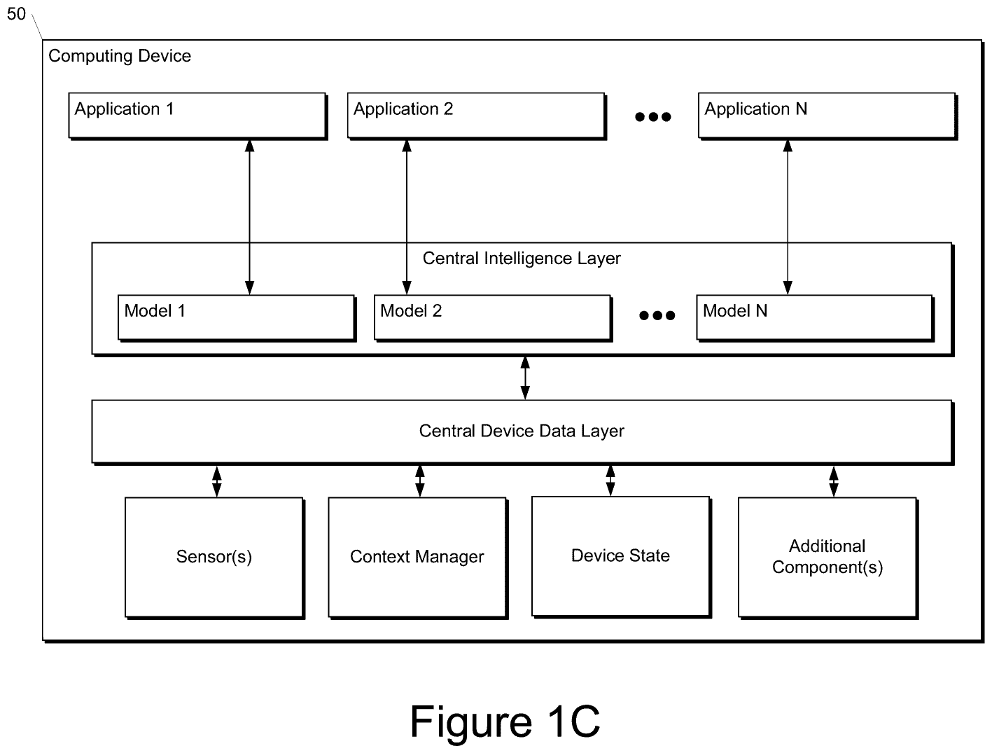

FIG. 1A depicts a block diagram of an example computing system 100 that performs layerwise multi-objective neural architecture search according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more models 120. For example, the models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models).

In some implementations, the one or more models 120 can be received from the server computing system 130 over network 180, stored in the user computing device memory 114, and then used or otherwise implemented by the one or more processors 112. In some implementations, the user computing device 102 can implement multiple parallel instances of a single model 120.

Additionally or alternatively, one or more models 140 can be included in or otherwise stored and implemented by the server computing system 130 that communicates with the user computing device 102 according to a client-server relationship. For example, the models 140 can be implemented by the server computing system 140 as a portion of a web service. Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models).

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained. The model trainer 160 can train the models 120 and/or 140 based on a set of training data 162.

In particular, the model trainer 160 can optimize models using layerwise multi-objective neural architecture search. For example, the model trainer 160 can, for each model layer N of a plurality of model layers M, select a candidate model layer from the preceding layer (e.g., layer N-1) using a selection mechanism (e.g., an evolutionary algorithm, trained predictor, etc.). The model trainer 160 can then select a search option from a number of search options, and use the search option to construct one or more candidate model layers for the model layer N+1. The model trainer 160 can group the candidate model layers based on their associated cost metrics. The model trainer 160 can then iteratively construct an optimized machine-learned model from the candidate layers according to a cost function that maximizes a performance of the optimized machine-learned model subject to a maximum cost.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 1A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 1B depicts a block diagram of an example computing device 10 that performs layerwise multi-objective neural architecture search according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that performs training and evaluation of candidate model layers for layerwise multi-objective neural architecture search according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

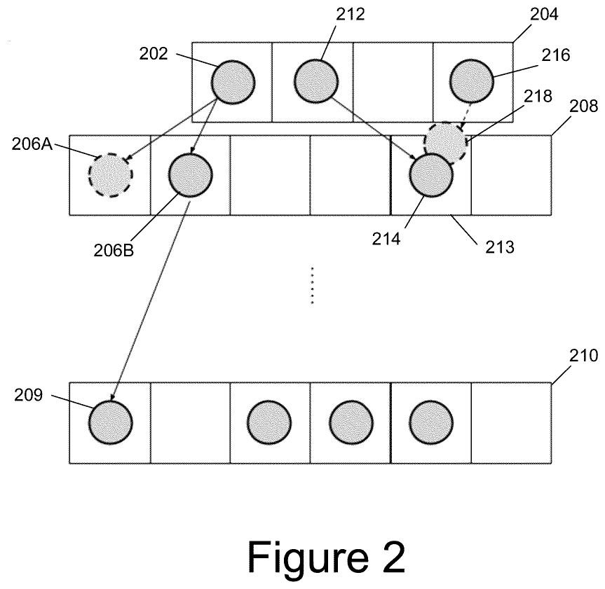

FIG. 2 is a data flow diagram for iteratively selecting candidate layers in a machine-learned model according to example embodiments of the present disclosure. More specifically, in some implementations, a computing system can, iterate through successive possible candidate layers following a current candidate model layer. For example, candidate model layer 202 can be a candidate layer for a current layer 204 (e.g., layer N). Based on the candidate model layer 202, the computing system can generate candidate model layers 206A and 206B (i.e., child layers) for the subsequent layer 208.

In some implementations, the computing system can filter (i.e., remove) candidate layers for the subsequent layer if the layer cannot be used to generate successive candidate layers that conform to the maximum cost of the model. For example, candidate model layer 206A can be a model layer such that any successive candidate model layers (e.g., generated for layer N+2) would exceed the maximum cost of the model. The computing system can filter the candidate model layer 206A (e.g., remove from potential inclusion) and can generate a candidate model layer 209 for subsequent layer 210 (e.g., layer N+2). If the layer 210 is the final layer of the model under evaluation, the computing system can return to the current layer 204 to evaluate candidate layer 212.

In some implementations, the computing system can group, or “bucketize” candidate model layers on a per-layer basis according to their associated cost metrics. For example, bucket 213 can be a bucket associated with a particular range of cost metrics. The computing system can generate candidate model layer 214 for model layer 208 based on the candidate model layer 212 for model layer 204. The computing system can evaluate candidate model layer 214 to determine an performance of the model layer and an associated cost metric, and based on the cost metric, can assign the candidate model layer to the bucket 213. Once evaluative iterations have been completed for the candidate model layer 212, the computing system can generate a candidate model layer 218 for the layer 208 (e.g., layer N+1) based on the candidate model layer 216 for layer 204 (e.g., layer n), and can evaluate the candidate model layer 218 to determine a performance and an associated cost metric. If the cost metric for the candidate model layer 218 also falls within the range associated with bucket 213, the computing system can determine which of the two candidate model layers provides a greater model performance. For example, if the candidate model layer 218 provides a greater performance than the candidate model layer 214, the computing system can replace the candidate model layer 214 with candidate model layer 218 within the bucket 213. In such fashion, the computing system can iteratively reduce the complexity of successive iterations, therefore substantially optimizing the efficiency of the neural architecture search.

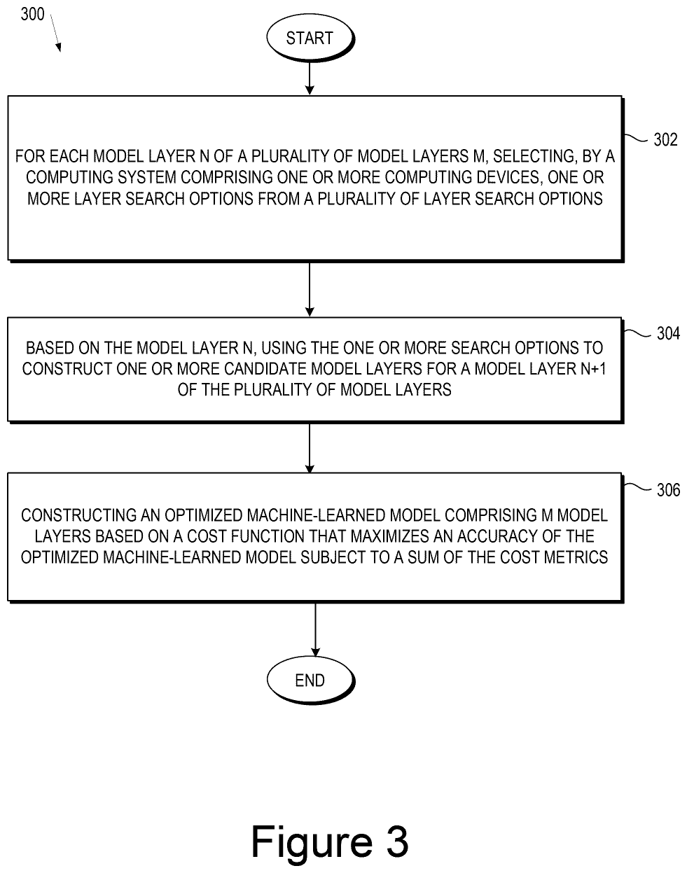

FIG. 3 depicts a flow chart diagram of an example method 300 to perform layerwise multi-objective neural architecture search according to example embodiments of the present disclosure. Although FIG. 3 depicts steps performed in a particular order for purposes of illustration and discussion, the methods of the present disclosure are not limited to the particularly illustrated order or arrangement. The various steps of the method 300 can be omitted, rearranged, combined, and/or adapted in various ways without deviating from the scope of the present disclosure.

At 302, a computing system can, for each model layer N of a plurality of model layers M, select one or more search options from a plurality of layer search options. In some implementations, prior to selecting the one or more search options from a plurality of layer search options, the computing system can receive an optimization request indicative of a quantity of layers M and the maximum cost.

At 304, the computing system can, for each model layer N of the plurality of model layers M, use the one or more search options to construct one or more candidate model layers for a model layer N+1 of the plurality of model layers based on the model layer N. The one or more candidate model layers can be respectively associated with one or more cost metrics. A cost metric can be indicative of a cost associated with inclusion of the candidate model layer in an optimized machine-learned model.

The cost associated with inclusion of the candidate model layer can be based on any type or manner of constraint(s). For example, the cost associated with selection of the candidate layer can include a constraint associated with the size of the candidate layer, a degree of energy consumption associated with the candidate layer, an inference latency associated with the candidate layer, etc.

In some implementations, the one or more candidate layers can include a plurality of candidate layers respectively associated with a plurality of cost metrics. Each of the plurality of cost metrics can be different, and each candidate layer can represent an optimal layer for a respectively associated cost metric. To use the one or more search options to identify the one or more candidate layers, the computing system can group the plurality of candidate layers into a plurality of candidate layer clusters. Each candidate layer cluster can be associated with a range of cost metrics.

In some implementations, grouping the plurality of candidate layers into the plurality of candidate layer clusters can include storing layer selection information indicative of the plurality of candidate layer clusters and each of the plurality of candidate layers. For example, the information can be, or otherwise include, a memorial table that stores lower-dimensional representations of the candidate model layers and associated information (e.g., cost metrics, performance metrics, etc.). To determine the candidate layer cluster of the plurality of candidate layer clusters, the computing system can determine the candidate layer cluster of the plurality of candidate layer clusters for the layer based on the cost function and layer selection information.

At 306, the computing system can construct an optimized machine-learned model comprising M model layers based on a cost function. The cost function can maximize a performance of the optimized machine-learned model subject to a sum of the cost metrics associated with each candidate model layer included in the optimized machine-learned model being less than a maximum cost.

In some implementations, constructing the optimized machine-learned model can include, for each layer of the optimized machine-learned model, determining a candidate layer cluster of the plurality of candidate layer clusters for the layer based on the cost function and the range of cost metrics associated with the candidate layer cluster. The computing system can select a candidate layer from the candidate layer cluster based on the cost function and the cost metrics associated with one or more layers selected prior to the candidate layer.

In some implementations, constructing the optimized machine-learned model based on the cost function can include, for a model layer N of the plurality of model layers M, determining, for a candidate model layer for the model layer N, that the cost metrics associated with each candidate model layer constructed for the model layer N+1 based on the candidate model layer are greater than a maximum cost. The computing system can filter the candidate model layer from inclusion in the optimized machine-learned model.

In some implementations, the computing system can determine that the performance associated with the optimized machine-learned model is less than a threshold degree of performance. The computing system can construct a second optimized machine-learned model comprising M model layers based on a second cost function. The second cost function can maximize a performance of the optimized machine-learned model subject to a sum of the cost metrics associated with each candidate model layer included in the optimized machine-learned model being less than a second maximum cost greater than the maximum cost.

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computing system for layer-wise neural architecture search with polynomial complexity to combinatorically construct an optimized machine-learned model, comprising:
one or more processors;
one or more non-transitory computer-readable media that store instructions that, when executed by the one or more processors, cause the participant computing device to perform operations, the operations comprising:
iteratively constructing, for each model layer of a plurality of model layers, one or more candidate model layers;
determining a cost metric for each of the candidate model layers, wherein a cost metric is indicative of a cost associated with inclusion of the candidate model layer in an optimized machine-learned model;
for each model layer, grouping the one or more respective candidate model layers into one or more candidate layer clusters, wherein each candidate layer cluster is associated with a range of cost metrics;
filtering at least one candidate model layer based the cost metric associated with the candidate model layer being greater than a threshold cost; and
constructing an optimized machine-learned model comprising a candidate model layer for each of the plurality of layers based on a cost function, wherein the cost function maximizes a performance metric of the optimized machine-learned model subject to a sum of the cost metrics associated with each candidate model layer included in the optimized machine-learned model being less than a maximum cost.

2. The computing system of claim 1, wherein the cost associated with selection of the candidate layer comprises one or more constraints, comprising:
a size of the candidate layer;
a degree of energy consumption associated with the candidate layer; or
an inference latency associated with the candidate layer.

3. The computing system of claim 1, wherein the operations further comprise:
determining, by the computing system, that the performance metric for the optimized machine-learned model is less than a threshold degree of performance; and
constructing, by the computing system, a second optimized machine-learned model comprising a candidate model layer for each of the plurality of layers based on the cost function,, wherein the second cost function maximizes the performance metric of the optimized machine-learned model subject to a sum of the cost metrics associated with each candidate model layer included in the optimized machine-learned model being less than a second maximum cost greater than the maximum cost.

4. A computer-implemented method to implement layerwise optimization of machine-learned models, the method comprising:
for each model layer N of a plurality of model layers M:
selecting, by a computing system comprising one or more computing devices, one or more layer search options from a plurality of layer search options;
based on the model layer N, using, by the computing system, the one or more search options to construct one or more candidate model layers for a model layer N+1 of the plurality of model layers, wherein the one or more candidate model layers are respectively associated with one or more cost metrics, wherein a cost metric is indicative of a cost associated with inclusion of the candidate model layer in an optimized machine-learned model; and
constructing, by the computing system, an optimized machine-learned model comprising M model layers based on a cost function, wherein the cost function maximizes a performance metric of the optimized machine-learned model subject to a sum of the cost metrics associated with each candidate model layer included in the optimized machine-learned model being less than a maximum cost.

5. The computer-implemented method of claim 4, wherein the cost associated with selection of the candidate layer comprises one or more constraints, comprising:
a size of the candidate layer;
a degree of energy consumption associated with the candidate layer; or
an inference latency associated with the candidate layer.

6. The computer-implemented method of claim 4, wherein the one or more candidate layers comprises a plurality of candidate layers respectively associated with a plurality of cost metrics, wherein each of the plurality of cost metrics is different, and wherein each candidate layer represents an optimal layer for a respectively associated cost metric; and
wherein using the one or more search options to identify one or more candidate layers further comprises:
grouping, by the computing system, the plurality of candidate layers into a plurality of candidate layer clusters, wherein each candidate layer cluster is associated with a range of cost metrics.

7. The computer-implemented method of claim 4, wherein constructing the optimized machine-learned model comprises, for each layer of the optimized machine-learned model:
determining, by the computing system, a candidate layer cluster of the plurality of candidate layer clusters for the layer based on the cost function and the range of cost metrics associated with the candidate layer cluster; and
selecting, by the computing system, a candidate layer from the candidate layer cluster based on the cost function and the cost metrics associated with one or more layers selected prior to the candidate layer.

8. The computer-implemented method of claim 4, wherein grouping the plurality of candidate layers into the plurality of candidate layer clusters further comprises storing, by the computing system, layer selection information indicative of the plurality of candidate layer clusters and each of the plurality of candidate layers; and
wherein determining the candidate layer cluster of the plurality of candidate layer clusters comprises determining, by the computing system, the candidate layer cluster of the plurality of candidate layer clusters for the layer based on the cost function and layer selection information.

9. The computer-implemented method of claim 4, wherein constructing the optimized machine-learned model based on the cost function comprises, for a model layer N of the plurality of model layers M:
determining, by the computing system for a candidate model layer for the model layer N, that the cost metrics associated with each candidate model layer constructed for the model layer N+1 based on the candidate model layer are greater than a maximum cost; and
filtering, by the computing system, the candidate model layer from inclusion in the optimized machine-learned model.

10. The computer-implemented method of claim 4, wherein the method further comprises:
determining, by the computing system, that the performance metric for the optimized machine-learned model is less than a threshold degree of performance; and
constructing, by the computing system, a second optimized machine-learned model comprising M model layers based on a second cost function, wherein the second cost function maximizes an accuracy of the optimized machine-learned model subject to a sum of the cost metrics associated with each candidate model layer included in the optimized machine-learned model being less than a second maximum cost greater than the maximum cost.

11. The computer-implemented method of claim 4, wherein, prior to selecting the one or more search options from a plurality of layer search options, the method comprises receiving, by the computing system, an optimization request indicative of a quantity of layers M and the maximum cost.

12. One or more non-transitory computer-readable media that store instructions that, when executed by the one or more processors, cause the participant computing device to perform operations, the operations comprising:
for each model layer N of a plurality of model layers M:
selecting one or more layer search options from a plurality of layer search options;
based on the model layer N, using the one or more search options to construct one or more candidate model layers for a model layer N+1 of the plurality of model layers, wherein the one or more candidate model layers are respectively associated with one or more cost metrics, wherein a cost metric is indicative of a cost associated with inclusion of the candidate model layer in an optimized machine-learned model; and
constructing an optimized machine-learned model comprising M model layers based on a cost function, wherein the cost function maximizes a performance metric of the optimized machine-learned model subject to a sum of the cost metrics associated with each candidate model layer included in the optimized machine-learned model being less than a maximum cost.

13. The one or more non-transitory computer-readable media of claim 12, wherein the cost associated with selection of the candidate layer comprises one or more constraints, comprising:
a size of the candidate layer;
a degree of energy consumption associated with the candidate layer; or
an inference latency associated with the candidate layer.

14. The one or more non-transitory computer-readable media of claim 12, wherein the one or more candidate layers comprises a plurality of candidate layers respectively associated with a plurality of cost metrics, wherein each of the plurality of cost metrics is different, and wherein each candidate layer represents an optimal layer for a respectively associated cost metric; and
wherein using the one or more search options to identify one or more candidate layers further comprises:
grouping the plurality of candidate layers into a plurality of candidate layer clusters, wherein each candidate layer cluster is associated with a range of cost metrics.

15. The one or more non-transitory computer-readable media of claim 12, wherein constructing the optimized machine-learned model comprises, for each layer of the optimized machine-learned model:
determining a candidate layer cluster of the plurality of candidate layer clusters for the layer based on the cost function and the range of cost metrics associated with the candidate layer cluster; and
selecting a candidate layer from the candidate layer cluster based on the cost function and the cost metrics associated with one or more layers selected prior to the candidate layer.

16. The one or more non-transitory computer-readable media of claim 12, wherein grouping the plurality of candidate layers into the plurality of candidate layer clusters further comprises storing, by the computing system, layer selection information indicative of the plurality of candidate layer clusters and each of the plurality of candidate layers; and
wherein determining the candidate layer cluster of the plurality of candidate layer clusters comprises determining the candidate layer cluster of the plurality of candidate layer clusters for the layer based on the cost function and layer selection information.

17. The one or more non-transitory computer-readable media of claim 12, wherein constructing the optimized machine-learned model based on the cost function comprises, for a model layer N of the plurality of model layers M:
determining, for a candidate model layer for the model layer N, that the cost metrics associated with each candidate model layer constructed for the model layer N+1 based on the candidate model layer are greater than a maximum cost; and
filtering the candidate model layer from inclusion in the optimized machine-learned model.

18. The one or more non-transitory computer-readable media of claim 12, wherein the operations further comprise:
determining that the performance metric for the optimized machine-learned model is less than a threshold degree of performance; and
constructing a second optimized machine-learned model comprising M model layers based on a second cost function, wherein the second cost function maximizes an accuracy of the optimized machine-learned model subject to a sum of the cost metrics associated with each candidate model layer included in the optimized machine-learned model being less than a second maximum cost greater than the maximum cost.
